(19) United States
(12) Patent Application Publication
(10) Pub. No.: US 2019/0265736 A1
(43) Pub. Date: Aug. 29, 2019

(54) INFORMATION PROVISION SYSTEM, VEHICULAR DEVICE, AND NON-TRANSITORY COMPUTER-READABLE STORAGE MEDIUM

(71) Applicant: DENSO CORPORATION, Kariya-city (JP)

(72) Inventors: Akira GOTO, Kariya-city (JP); Akihiro SAKAKIBARA, Kariya-city (JP)

(21) Appl. No.: 16/408,798

(22) Filed: May 10, 2019

Related U.S. Application Data
(63) Continuation of application No. PCT/JP2017/032098, filed on Sep. 6, 2017.

(30) Foreign Application Priority Data
Nov. 24, 2016 (JP) 2016-227814

(51) Int. Cl. G05D 1/10; G08G 5/00; H04N 5/445; G06K 9/00; G06T 7/20; G06T 7/70; G05D 1/00; B64C 39/02

(52) U.S. Cl. CPC G05D 1/106; B64C 2201/146; H04N 5/445; G06K 9/0063; G06T 7/20; G06T 7/70; G05D 1/0038; B64C 39/024; G06T 2207/10032; G06T 2207/30236; G06T 2207/30252; B64C 2201/127; B64C 2201/208; B64C 2201/141; G08G 5/0069

(57) ABSTRACT

An information provision system includes: a flying device for imaging a periphery of a vehicle from above, communicating with the vehicle, controlling flight by remote control and flight by autonomous control, and controlling to transmit an image to the vehicle; and a vehicular device for communicating with the flying device, and controlling to display the image on a vehicle-side display unit in real time.

### CROSS REFERENCE TO RELATED APPLICATIONS

The present application is a continuation application of International Patent Application No. PCT/JP2017/032098 filed on Sep. 6, 2017, which designated the United States and claims the benefit of priority from Japanese Patent Application No. 2016-227814 filed on Nov. 24, 2016. The entire disclosures of all of the above applications are incorporated herein by reference.

### TECHNICAL FIELD

The present disclosure relates to an information provision system, a vehicular device, and a non-transitory computer-readable storage medium for providing information on a periphery of a vehicle.

### BACKGROUND

Conventionally, for example, there has been known a technique of providing information on a front, sides, or a rear of a vehicle to a driver. At this time, it is considered that safety can be enhanced if information on a position which cannot be viewed by the driver can be provided. For that reason, for example, when multiple vehicles are traveling in tandem, vehicle information is transmitted to a driver of a succeeding vehicle according to a difference in a color or a flashing mode of an indicator light provided in each vehicle.

### SUMMARY

According to an example embodiment an information provision system includes: a flying device for imaging a periphery of a vehicle from above, communicating with the vehicle, controlling flight by remote control and flight by autonomous control, and controlling to transmit an image to the vehicle; and a vehicular device for communicating with the flying device, and controlling to display the image on a vehicle-side display unit in real time.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram schematically showing a configuration of an information provision system according to an embodiment;

FIG. 2 is a diagram schematically showing a storage mode of a flying device;

FIG. 3 is a diagram schematically showing an example of an image captured by a camera;

FIG. 4 is a diagram schematically showing a configuration of the flying device;

FIG. 5 is a diagram schematically showing a configuration of a vehicular device;

FIG. 6 is a diagram schematically showing a display example of an image display unit;

FIG. 7 is a diagram schematically showing a display example of an operation display unit;

FIG. 8 is a diagram schematically showing a display example of a situation display unit;

FIG. 9 is a diagram showing a flow of a takeoff process by the flying device;

FIG. 10 is a diagram showing a flow of a takeoff preparation process by the vehicular device;

FIG. 11 is a diagram showing a flow of an information collection process by the flying device;

FIG. 12 is a diagram showing a flow of a position control process by the flying device;

FIG. 13 is a diagram showing a flow of an information provision process by the vehicular device;

FIG. 14 is a diagram showing a flow of an identification process by the vehicular device;

FIG. 15 is a diagram schematically showing a procedure for determining a possibility of coming in contact with a moving object;

FIG. 16 is a diagram schematically showing a procedure for determining a possibility of coming in contact with a stationary object;

FIG. 17 is a diagram showing a flow of a notification process by the vehicular device;

FIG. 18 is a diagram schematically showing an imaging range in each imaging pattern;

FIG. 19 is a diagram showing a flow of a return process by the flying device; and

FIG. 20 is a diagram showing a flow of a return preparation process by the vehicular device.

### DETAILED DESCRIPTION

In an example, although a driver of a succeeding vehicle can acquire the information on an invisible place, the acquired information is different from that actually viewed. For example, an inter-vehicle time from a preceding vehicle is transmitted as information on a mode different from that actually viewed by the driver such as a difference in color of the indicator light. Hereinafter, information on a mode different from that actually viewed by the driver will be referred to as conveniently schematic information.

However, when the driver acquires the schematic information, the driver considers what the information means. At this time, the driver's attention may deviate from driving by considering the meaning of the acquired information. In addition, since the vehicle is traveling even while the meaning of the information is considered, there is a possibility that the vehicle is too close to an obstacle or the like, for example, at a point in time when the meaning can be grasped.

In addition, it is considered that the schematic information is often not accompanied by a sense of reality such as a driver's actual visibility. For that reason, there is a problem that it is difficult to immediately determine whether or not the information is to be noted.

In the present disclosure, information is provided such that meaning can be easily understood, the information has a sense of reality, the information can predict a potential danger in advance, and the information can strongly alert a driver.

According to an example embodiment, an information provision system includes: a flying device including an imaging unit that images a periphery of a vehicle from above, a flight-side communication unit that communicates with the vehicle, and a flight-side control unit that controls flight by remote control and flight by autonomous control, and controls transmitting an image captured by the imaging unit to the vehicle; and a vehicular device including a vehicle-side communication unit that communicates with the flying device, and a vehicle-side control unit that controls displaying an image captured by the flying device and received by the vehicle-side communication unit on a vehicle-side display unit in real time.

Also, according to an example embodiment, a vehicular device includes: a vehicle-side communication unit that communicates with a flying device having an imaging unit and imaging a periphery of a vehicle from above; and a vehicle-side control unit that controls displaying an image captured by the flying device and received by the vehicle-side communication unit on a vehicle-side display unit in real time.

Further, according to an example embodiment, an information provision program for controlling a vehicle-side control unit in a vehicular device, communicably connected to a flying device having an imaging unit and imaging a periphery of a vehicle from above, to execute: a process of receiving an image captured by the flying device; and a process of displaying a received image on a vehicle-side display unit in real time.

Embodiments will be described below with reference to the drawings.

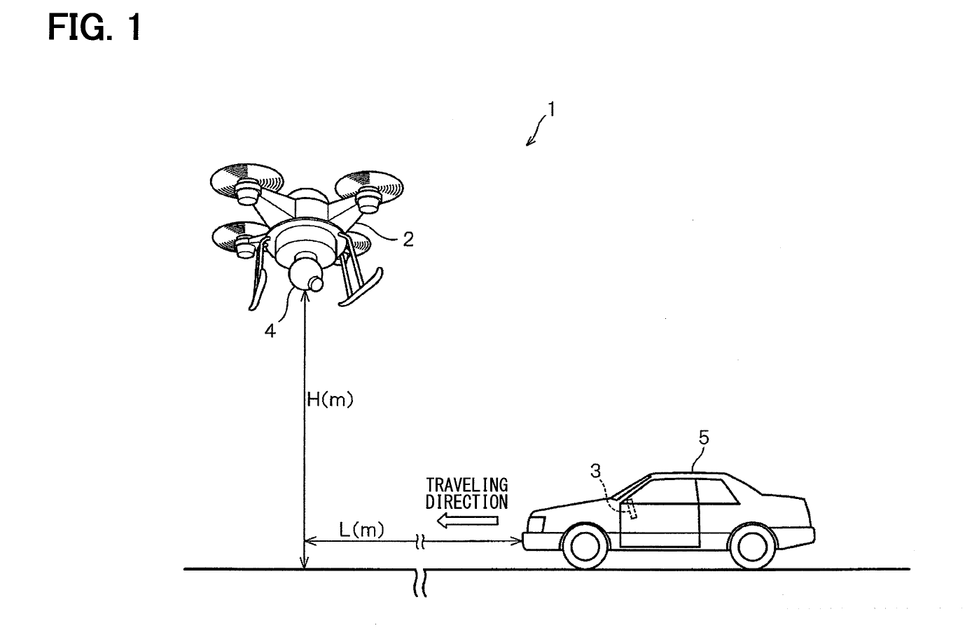

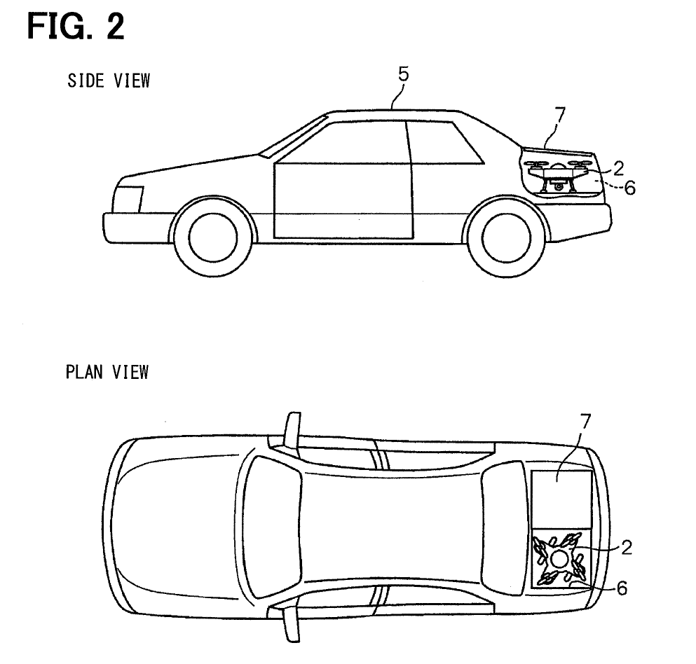

First, an outline of an information provision system 1 according to the present embodiment will be described with reference mainly to FIGS. 1 and 2. As shown in FIG. 1, the information provision system 1 includes a flying device 2 and a vehicular device 3.

The flying device 2 has a camera 4 as an imaging unit, and images a periphery of the vehicle 5 from above. In this example, the periphery of the vehicle 5 means a range including at least one of a front, sides, and a rear of the vehicle 5. In that case, the flying device 2 can image a range including the vehicle 5 or a range not including the vehicle 5.

The flying device 2 is capable of changing the range (hereinafter, referred to as an imaging range) imaged by the camera 4. Specifically, the flying device 2 can change the imaging range by moving a position of the flying device 2 itself, changing an orientation of the camera 4, switching zooming of the camera 4, and the like. However, in the present embodiment, the flying device 2 captures an image in a state in which an upper side of the captured image substantially coincides with a traveling direction of the vehicle 5.

In addition, the flying device 2 can flight under autonomous control, that is, flight in a state in which an operation by a driver or the like of the vehicle 5 is unnecessary in accordance with a program incorporated in advance.

Hereinafter, flight by autonomous control is referred to as autonomous flight. In addition, the flying device 2 can flight by remote control, that is, flight while being remotely controlled by an occupant of the vehicle 5.

The flying device 2 is capable of capturing images in both moving and still images, as well as in both color and monochrome.

As shown in FIG. 2, the flying device 2 is stored in a storage chamber 6 in, for example, a trunk room of the vehicle 5. The storage chamber 6 is opened and closed upward by, for example, a slide door 7 which slides in a vehicle width direction. A storage mode of the flying device 2 is not limited to the above configuration.

As will be described later, when a takeoff instruction is transmitted from the occupant of the vehicle 5 such as a driver, or when a predetermined takeoff requirement is satisfied, the flying device 2 takes off by autonomous flight from the vehicle 5. The flying device 2 returns to the vehicle 5 by autonomous flight when a return instruction is transmitted from the occupant of the vehicle 5 or when a predetermined return requirement is satisfied.

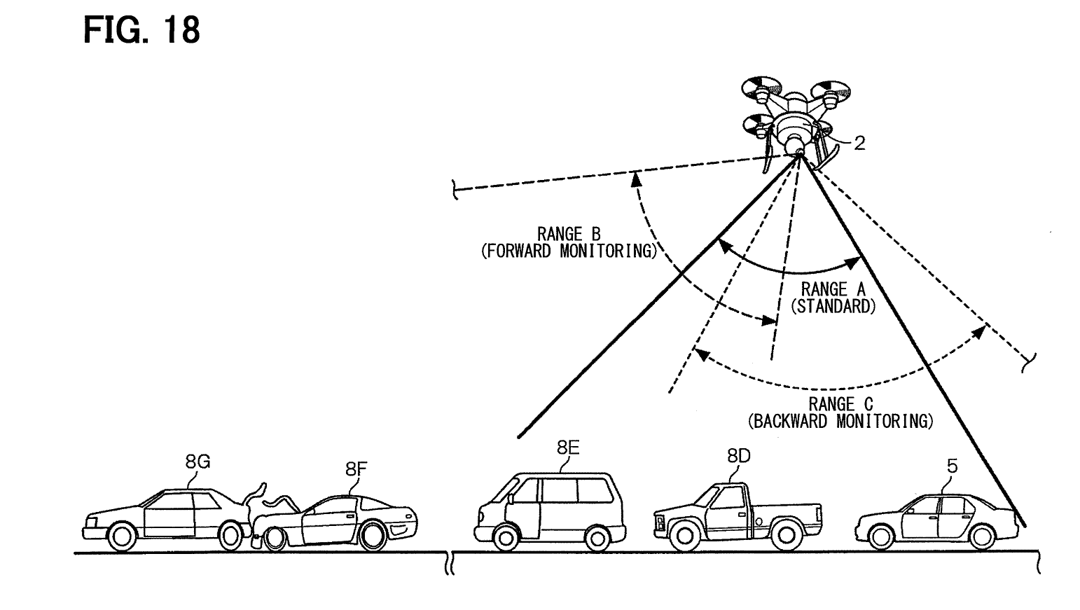

When the flying device 2 takes off from the vehicle 5, in a normal use mode, the flying device 2 moves at a position ahead from the vehicle 5 by a predetermined distance (L) and above by a predetermined altitude (H), as shown in FIG. 1, by autonomous flight. The distance (L) and the altitude (H) are initially set as a flight position in an imaging pattern (refer to FIG. 18, etc.) of “standard” which will be described later. Hereinafter, the position ahead from the vehicle 5 by the predetermined distance (L) and above by the predetermined altitude (H) will be referred to as a standard position for convenience.

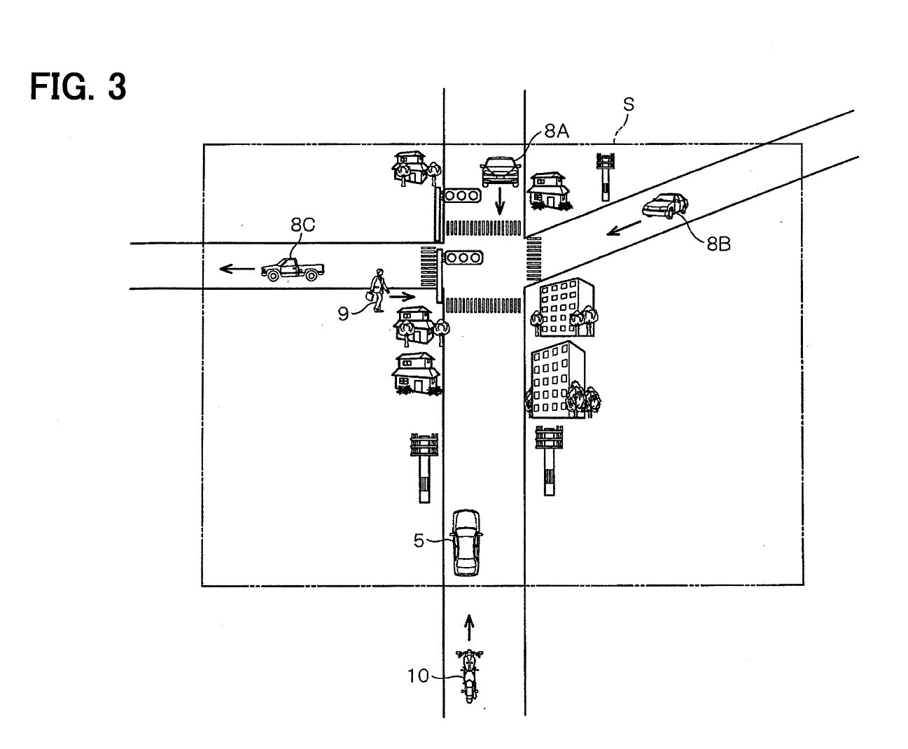

Upon reaching the standard position, the flying device 2 captures an image in the traveling direction of the vehicle 5, while maintaining a predetermined positional relationship with the vehicle 5 by autonomous flight, in other words, while following a change in the position due to the vehicle travel. At that time, for example, as shown in FIG. 3, as an example, the flying device 2 captures an image of a predetermined imaging range (S) as a so-called bird's-eye view in a state where the vehicle 5 is included in the image.

In FIG. 3, in the imaging range (S), the situations around the vehicle 5 are imaged, such as an intersection existing in front of the vehicle 5, another vehicle 8A and another vehicle 8B traveling in a direction approaching the intersection, another vehicle 8C traveling in a direction away from the intersection, a moving object such as a person 9 positioned in the vicinity of the intersection, and stationary objects such as a house, a building, or an electric pole positioned outside the road.

Arrows shown in FIG. 3 are provided for the purpose of description, and are not actually imaged. There is also a motorcycle 10 which is not in the imaging range (S) of the camera 4 but travels in the same direction behind the vehicle 5.

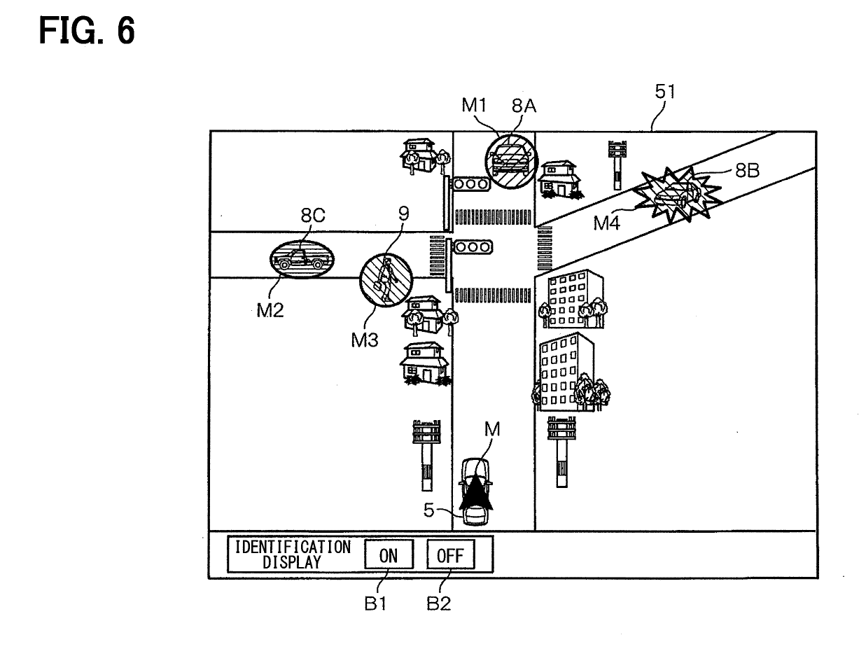

Images captured on the flying device 2 side are continuously transmitted to the vehicular device 3 by wireless communication. The vehicular device 3 displays an image continuously transmitted from the flying device 2 on a vehicle-side display unit 54 (refer to FIG. 6). In other words, the vehicular device 3 displays an image capable of grasping information about the periphery of the vehicle 5 in real time. The vehicular device 3 may be fixedly provided on the vehicle 5, or may be detachably provided on the vehicle 5, such that the vehicular device 3 can be taken out of the vehicle.

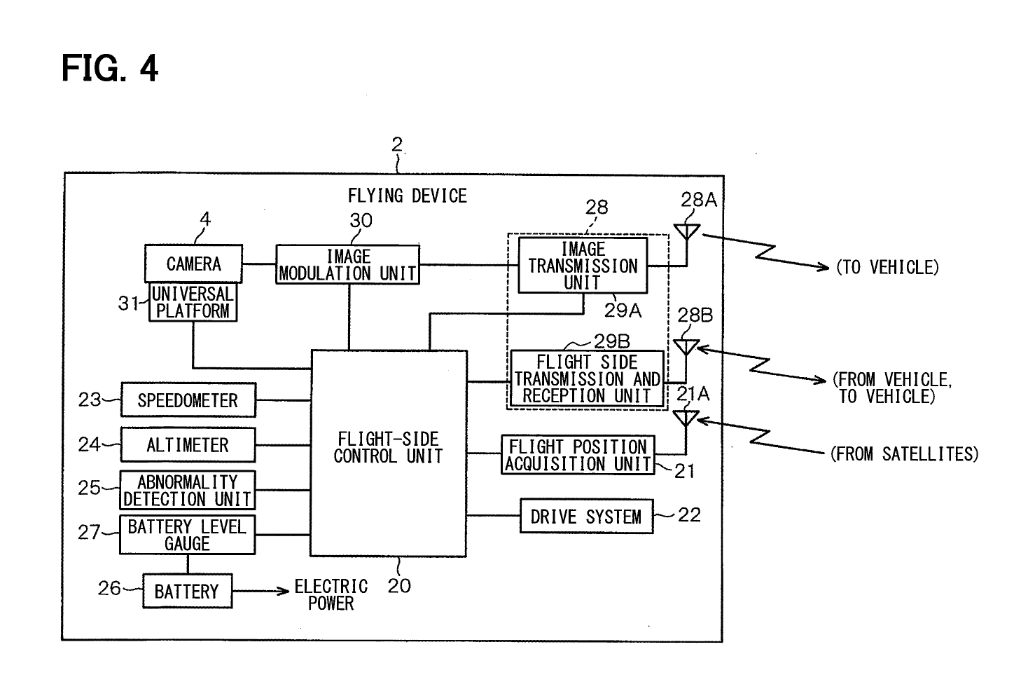

Next, details of the flying device 2 and the vehicular device 3 will be described with reference mainly to FIGS. 4 to 20.

As shown in FIG. 4, the flying device 2 has a flight-side control unit 20. The flight-side control unit 20 includes a storage unit or the like configured by a microcomputer, a memory, or the like (not shown). The flight-side control unit 20 controls the flying device 2 by executing a program stored in the storage unit.

The flight-side control unit 20 is connected to a flight position acquisition unit 21 that acquires a flight position indicating a position of the flight-side control unit 20. In the present embodiment, the flight position acquisition unit 21 is configured by a GPS (Global Positioning System) device, and acquires a flight position by receiving radio waves from a GPS satellite by an antenna 21A, as has been well known. In the present specification, the current position of the flying device 2 is referred to as a flight position even in a state in which the flying device 2 is stored in the vehicle 5, not limited to the flight state.

The flight-side control unit 20 is connected to a drive system 22 having a propeller or the like, a speedometer 23 for measuring a speed, an altimeter 24 for measuring an altitude, an abnormality detection unit 25 for detecting an abnormality, a battery level meter 27 for measuring a level of the battery 26, and the like. The flight-side control unit 20 drives the drive system 22 based on the flight position acquired by the flight position acquisition unit 21 and various data measured or detected by each unit, although a detailed description of the flight control is omitted.

In the case of autonomous flight, the flight-side control unit 20 determines whether or not the flight position is a normal position and flies. On the other hand, when receiving an instruction from the flight-side communication unit 28, the flight-side control unit 20 flies by remote control based on the received instruction. For that reason, although not shown, the flying device 2 also has a detection unit for detecting and avoiding objects around the flying device 2, such as a gyro sensor and a millimeter wave radar.

In the present embodiment, the flight-side communication unit 28 has two functional blocks of an image transmission unit 29A and a flight side transmission and reception unit 29B. In the present embodiment, the image transmission unit 29A and the flight side transmission and reception unit 29B are each configured by an individual communication IC, and an antenna 28A and an antenna 28B are provided in the respective communication ICs.

The flight side transmission and reception unit 29B receives data transmitted from the vehicular device 3, such as a takeoff instruction, a return instruction, and an adjustment instruction for the flight position or the direction of the camera 4, which will be described later. In addition, the flight side transmission and reception unit 29B transmits data such as a flight position and occurrence of an abnormality, for example. However, in the present embodiment, the flight side transmission and reception unit 29B does not transmit the image captured by the camera 4.

The image transmission unit 29A transmits the image captured by the camera 4 to the vehicle 5. In other words, the image transmission unit 29A is provided exclusively for image transmission. This is because the image has a relatively large amount of data and the image can be continuously transmitted. More specifically, the image transmission unit 29A transmits data obtained by modulating the image captured by the camera 4 by an image modulation unit 30. In order to simplify the description, even when the modulated data is transmitted, the case is called “the image is transmitted” in the following description.

The image modulation unit 30 modulates the image in order to reduce a communication load when transmitting the image. In this case, the modulation of the image mainly means data compression of the image. In the present embodiment, since it is basically assumed that a moving image is transmitted, the image modulation unit 30 compresses data by employing a well-known moving image compressing standard method such as MPEG. When a still image is transmitted, a well-known still image compression standard method may be employed in the same manner.

The camera 4 is mounted on a universal platform 31 whose angle can be adjusted. The universal platform 31 can adjust the orientation of the camera 4 by changing the angle based on an instruction from the flight-side control unit 20. For that reason, the flying device 2 can adjust only the orientation of the camera 4 without changing a flight posture of the flying device 2 itself, for example, by adjusting the angle of the universal platform 31.

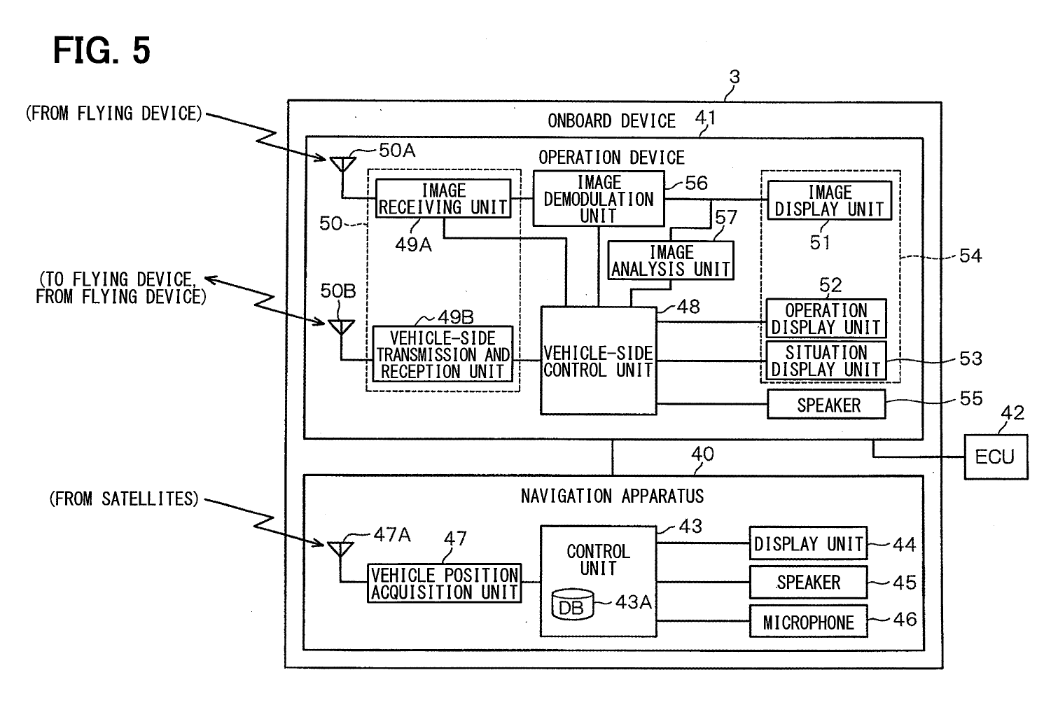

As shown in FIG. 5, the vehicular device 3 includes a navigation apparatus 40 and an operation device 41 in the present embodiment. The navigation apparatus 40 and the operation device 41 are connected so as to be able to communicate with each other. The vehicular device 3 is also communicably connected to an ECU 42 (Electronic Control Unit) provided in the vehicle 5 in order to acquire vehicle information capable of identifying a behavior of the vehicle 5, such as a velocity of the vehicle 5 and the operation of a blinker.

The navigation apparatus 40 includes a control unit 43, a display unit 44, a speaker 45, a microphone 46, a vehicle position acquisition unit 47, and the like. The vehicle position acquisition unit 47 is configured by a GPS device, and has an antenna 47A for receiving the radio waves from the satellite. The navigation apparatus 40 acquires the vehicle position indicating the current position of the vehicle 5 by the vehicle position acquisition unit 47, and guides the vehicle 5 to a destination set by the driver or the like with the use of the map data stored in a DB 43A (DataBase). In other words, the navigation apparatus 40 corresponds to a route guidance unit that guides the vehicle 5 to a predetermined destination.

The navigation apparatus 40 is configured to be able to output route information capable of identifying a vehicle position, map data, and a route to a destination to the operation device 41. At that time, the map data output to the operation device 41 may include a shape of the road on which the vehicle 5 is traveling, whether or not there is a crossing or merging road, a connection position of the crossing or merging road if there is the crossing or merging road, a position of a building or a parking lot in the vicinity of the vehicle position, and the like.

The operation device 41 is a device that has an operation function and a control function of the flying device 2, and is generally used in combination with the flying device 2. The operation device 41 includes a vehicle-side control unit 48. The vehicle-side control unit 48 has a storage unit or the like configured by a microcomputer, a memory, or the like (not shown), and executes a program stored in the storage unit to control the reception of the image, an instruction to the flying device 2, or the like in the present embodiment. The vehicle-side control unit 48 also controls a communication with the navigation apparatus 40 and the ECU 42.

The operation device 41 includes a vehicle-side communication unit 50 having two functional blocks of an image receiving unit 49A and a vehicle-side transmission and reception unit 49B. In the present embodiment, the image receiving unit 49A and the vehicle-side transmission and reception unit 49B are each configured by an individual communication IC, and an antenna 50A and an antenna 50B are provided for the respective communication ICs.

The image receiving unit 49A receives an image transmitted from the flying device 2. In the present embodiment, the image receiving unit 49A is provided exclusively for receiving an image.

The vehicle-side transmission and reception unit 49B transmits a takeoff instruction, a return instruction, an adjustment instruction of the flight position or the orientation of the camera 4, and the like, which will be described later, to the flying device 2. The vehicle-side transmission and reception unit 49B transmits the vehicle position acquired from the navigation apparatus 40 to the flying device 2. In addition, the vehicle-side transmission and reception unit 49B receives data such as the flight position and the occurrence of an abnormality, for example, from the flying device 2. However, the vehicle-side transmission and reception unit 49 B does not receive the image.

The operation device 41 includes a vehicle-side display unit 54 having three functional blocks, i.e., an image display unit 51, an operation display unit 52, and a situation display unit 53, and a speaker 55. In the present embodiment, the image display unit 51, the operation display unit 52, and the situation display unit 53 have respective displays. Each display device is provided with a touch panel (not shown) corresponding to each screen.

For that reason, the driver or the like can input a desired operation by touching the screen of each of the displays. In other words, the vehicle-side display unit 54 also functions as an operation unit. The operating unit may be provided separately from the operation unit 52.

As shown in FIG. 6, the image display unit 51 displays, in real time, an image demodulated by the image demodulation unit 56 after being received by the image receiving unit 49A. Details of the display content will be described later. The image display unit 51 is connected to an image analysis unit 57 for analyzing an image. The image display unit is provided at a position within a field of view even when the driver faces the front, for example, around a steering wheel in an instrument panel. In other words, the driver can visually recognize marks M1 to M4 and the like, which will be described later, even when the driver faces the front.

The image analysis unit 57 corresponds to an object detection unit that detects an object in an image, an approach determination unit that determines whether or not the moving object approaches the vehicle 5 or the course of the vehicle 5 when the object is a moving object, an intersection determination unit that determines whether or not the traveling direction of the moving object intersects with the traveling direction of the vehicle 5 when the object is a moving object, and a stationary object determination unit that determines whether or not the stationary object is positioned on the course of the vehicle 5 when the object is a stationary object.

In addition, the image analysis unit 57 corresponds to an image generation unit that generates an image showing an object in an identifiable manner, an identification image different in a mode between a moving object determined to approach the vehicle 5 and a moving object determined not to approach the vehicle 5, an identification image different in mode between a moving object whose traveling direction is determined to intersect with a latitude direction of the vehicle 5 and a moving object whose traveling direction is determined not to intersect with the latitude direction, and an identification image showing a stationary object determined to be positioned on the course in an identifiable manner.

The image analysis unit 57 corresponds to a contact determination unit that determines the possibility of coming in contact between the detected object and the vehicle 5, such as a moving object determined to intersect with the direction or a stationary object positioned on the course. At this time, the image analysis unit 57 generates an identification image indicating the possibility of coming in contact between the vehicle 5 and the moving object or the stationary object in stages in an identifiable manner.

The vehicular device 3 displays the detection result of the moving object or the like by the image analysis unit 57 and the image showing the moving object or the like generated by the image analysis unit 57 on the image display unit 51 in the identifiable manner so as to overlap with the image captured by the flying device 2.

At this time, when the position of the object in the image changes according to the movement of the vehicle 5 or the flying device 2, the vehicular device 3 displays the image while changing the display position of the identification image according to a change in the display position of the object. Whether or not to display the identification image can be switched by operating an identification display on button B1 or an identification display off button B2.

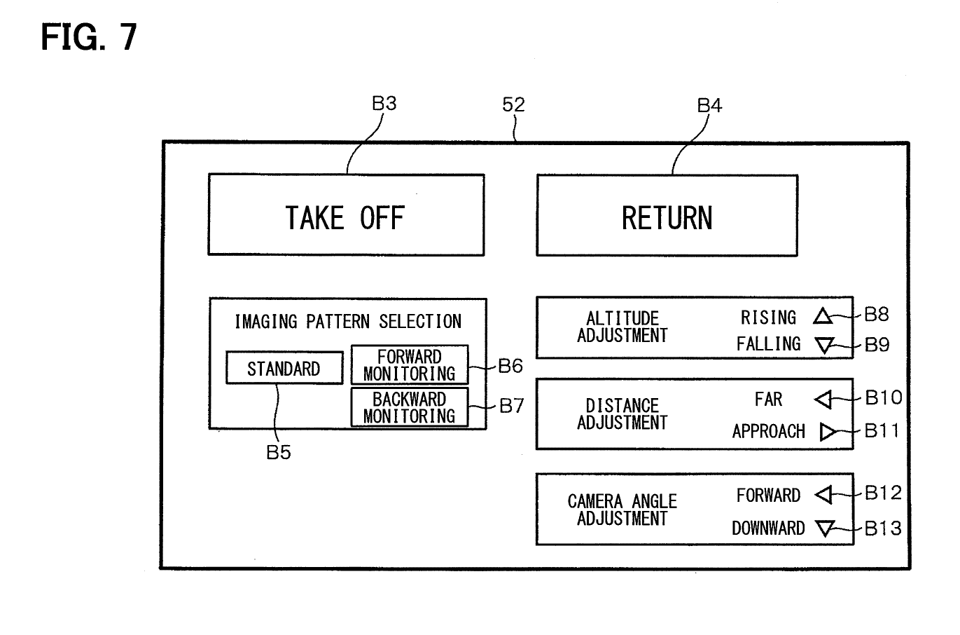

As shown in FIG. 7, the operation display unit 52 displays various operation buttons for inputting various operations on the flying device 2. The operation display unit 52 corresponds to an operation unit for inputting an adjustment instruction for adjusting at least one of the position of the flying device 2 and the orientation of the camera 4 with respect to the vehicle 5.

In the case of the present embodiment, a takeoff button B3 for instructing the takeoff of the flying device 2 and a return button B4 for instructing the return are displayed on the operation display unit 52. The operation display unit 52 displays, as buttons for adjustment, a standard button B5 for selecting an imaging pattern (refer to FIG. 18), a forward monitoring button B6 and a rearward monitoring button B7, an up button B8 and a down button B9 for adjusting the altitude of the flying device 2, a far button B10 and an approach button B11 for adjusting a distance to the vehicle 5, and a forward button B12 and a downward button B13 for adjusting an angle of the camera 4.

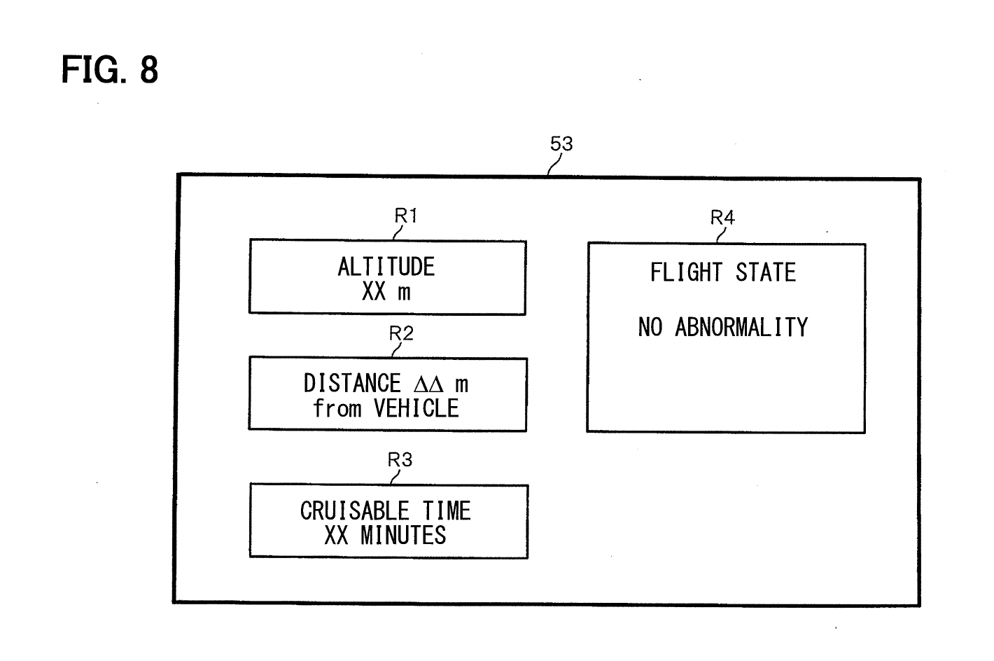

The situation display unit 53 displays various situations of the flying device 2. In the present embodiment, as shown in FIG. 8, the situation display unit 53 is provided with an altitude display region R1 for displaying the altitude of the flying device 2, a distance display region R2 for displaying A distance from the vehicle 5, a time display region R3 for displaying a cruisable time, and an abnormality display region R4 for displaying the presence or absence of an abnormality. The situation display unit 53 displays information corresponding to each region.

As will be described later, the speaker 55 outputs a message to the driver, such as detection of the moving object, by voice. The speaker 55 and the image display unit 51 function as a notification unit that performs various types of notification including information about the periphery of the vehicle 5 to the driver.

Next, the operation of the configuration described above will be described.

As described above, when information around the vehicle 5 is provided to the driver or the like, it is difficult to immediately determine the necessity of the information even if the schematic information is provided to the driver or the like, and it is considered that there is often no sense of reality as in the case where the driver actually views the periphery of the vehicle 5. In other words, it is considered that information whose meaning can be easily grasped, and which is accompanied by the sense of reality can strongly alert the driver.

At this time, it is considered that, if information on the position which is not visible to the driver of the vehicle 5 can be provided, the information leads to early detection of danger or the like, and makes it possible to provide a margin for dealing with the danger or the like. Hereinafter, the information on the position which is not visible to the driver will be referred to as “out-of-view information” for the sake of convenience.

Further, if the out-of-view information can be provided, it is considered that a psychological state of the driver can be improved, such that the driver's irritation can be solved. In other words, it is considered that the provision of the out-of-view information can assist the driving not only from a physical aspect such as avoidance of contact, for example, but also from a psychological aspect.

The driver tends to become irritated and psychologically unstable when the vehicle 5 is prevented from traveling, for example, by being caught in a traffic congestion. At this time, when a traffic congestion occurs due to a situation of a position which is not visible to the driver, it is considered that the irritation tendency becomes stronger because the cause of the traffic congestion is unknown. On the other hand, if the cause of traffic congestion can be grasped, it is considered to be psychologically stable by convincing or giving up.

As factors that hinder the traveling of the vehicle 5, for example, a dropped object on a road, a failed vehicle, an accident, an illegal parking, a construction work, a traffic regulation, a crosser crossing a road, and the like are considered. If those events occur at a position which is invisible to the driver, the driver cannot normally grasp the cause. In addition, it is considered that the psychological instability may be caused by the fact that it is not known how long to wait when the parking lot is waiting for space.

Those causes do not necessarily occur at positions visible to the driver. In addition, for example, a monitoring device may be installed at a large intersection or the like, but such a monitoring device does not necessarily obtain information on a position desired by the driver.

Therefore, the information provision system 1 can easily grasp the meaning of the provided information and provide the driver with realistic information in the following manner.

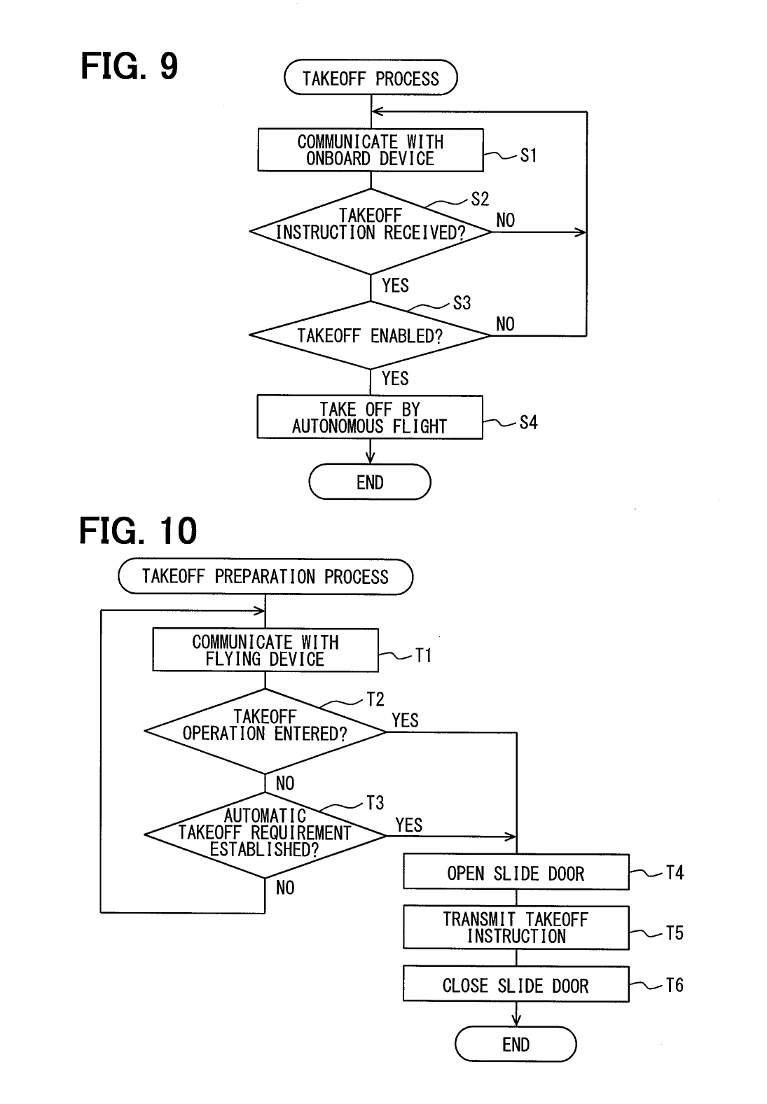

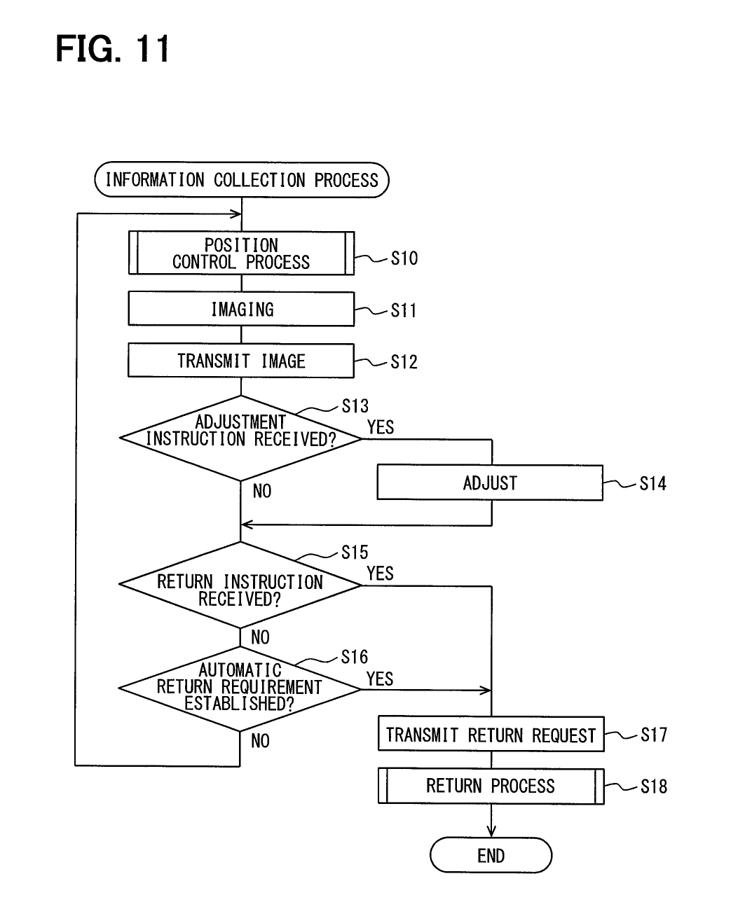

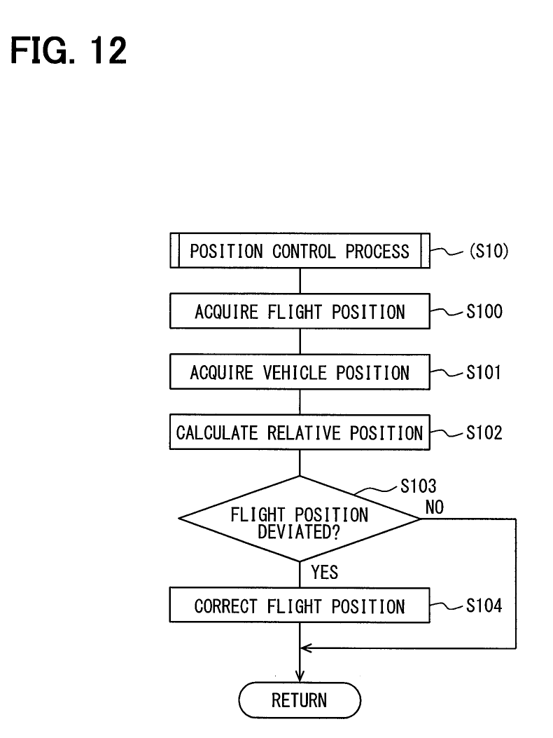

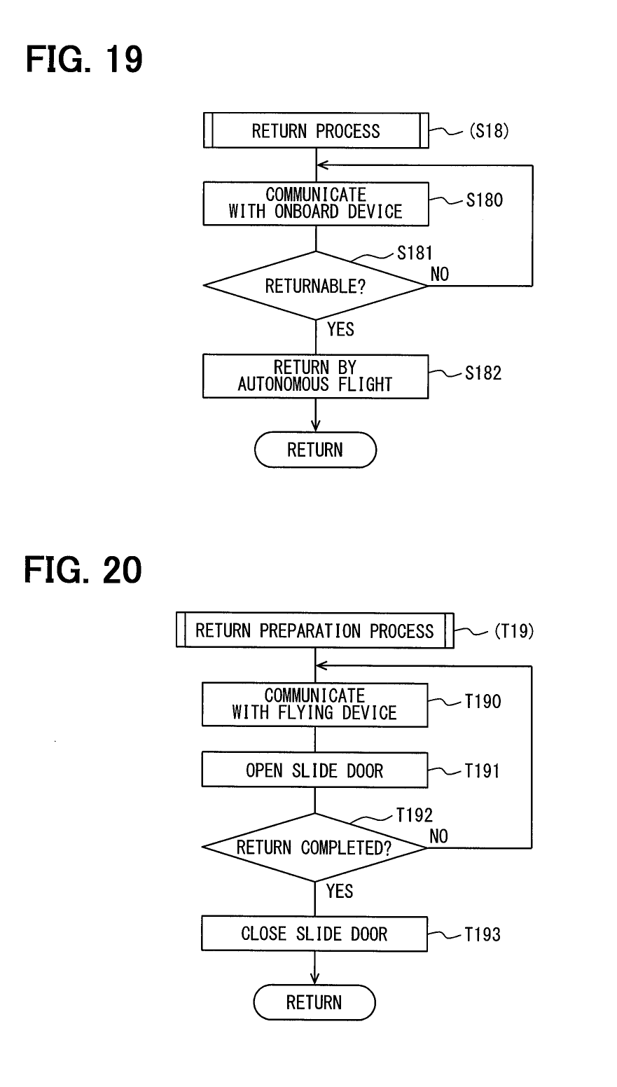

Hereinafter, a procedure for taking off the flying device 2, a procedure for providing information to the driver, a procedure for instructing an adjustment to the flying device 2, and a procedure for returning the flying device 2 will be described in order. A takeoff process shown in FIG. 9, an information collection process shown in FIG. 11, a position control process shown in FIG. 12, and a return process shown in FIG. 19, which will be described below, mainly show a process of a program executed by the flight-side control unit 20.

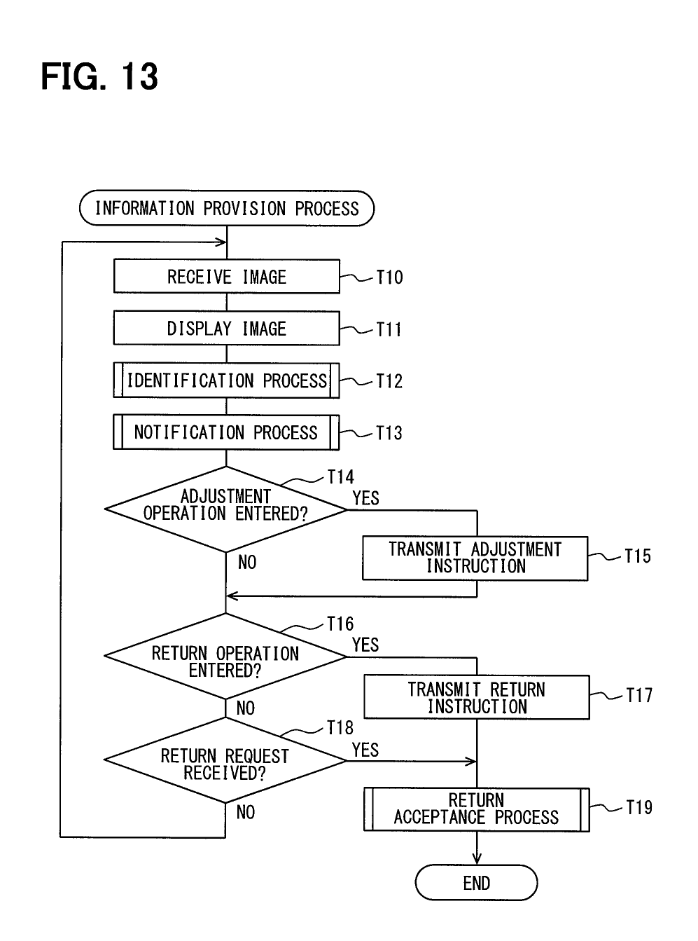

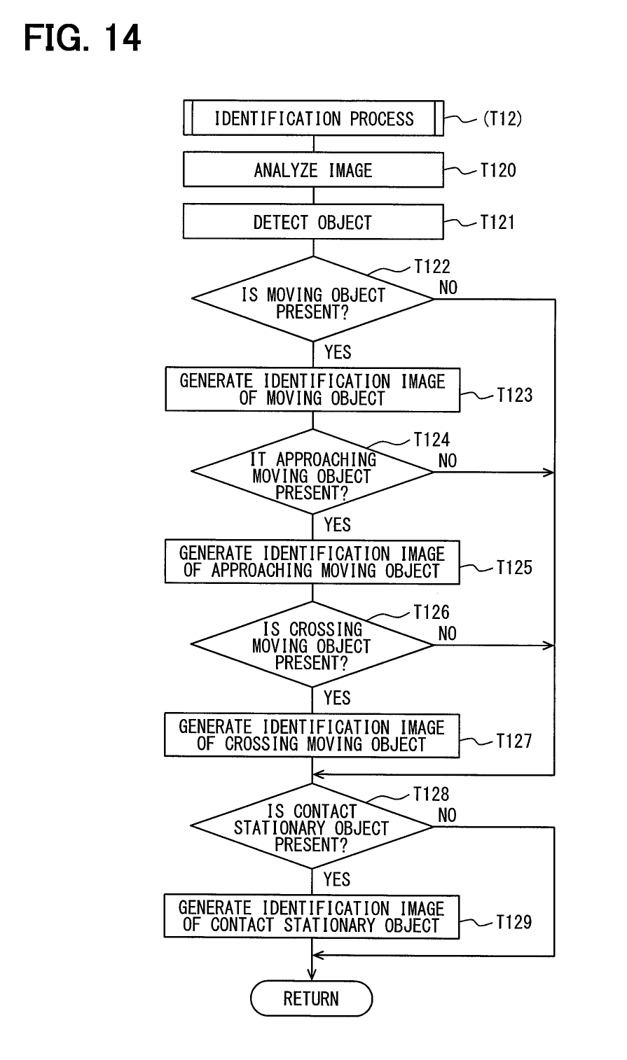

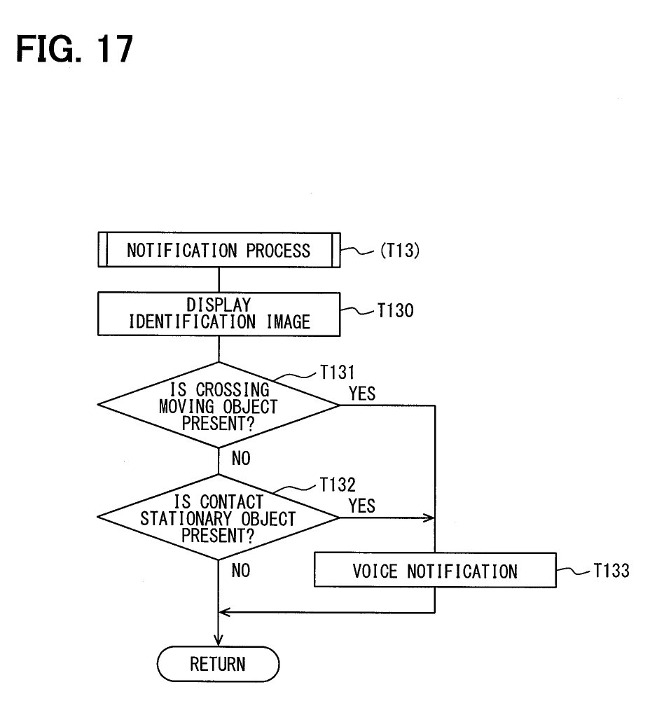

A takeoff preparation process shown in FIG. 10, an information provision process shown in FIG. 13, an identification process shown in FIG. 14, a notification processing shown in FIG. 17, and a return preparation process shown in FIG. 20, which will be described below, mainly show processing of a program to be executed by the vehicle-side control unit 48.

<Procedure for Taking Off Flying Device 2>

The takeoff procedure of the flying device 2 will be described mainly with reference to FIGS. 9 and 10.

As described above, the flying device 2 is stored in the storage chamber 6. When a power is turned on, the flying device 2 executes the takeoff process shown in FIG. 9. In the takeoff process, the flying device 2 communicates with the vehicular device 3 as necessary (51). In this Step S1, for example, a level of the battery 26 of the flying device 2, a result of self-diagnosis, and the like are exchanged.

Next, the flying device 2 determines whether or not a takeoff instruction has been received (S2). When it is determined that the takeoff instruction has not been received (NO in S2), the flying device 2 shifts to Step S1 and waits for reception of the takeoff instruction.

On the other hand, when the power is turned on, the vehicular device 3 executes the takeoff preparation process shown in FIG. 10 in order to prepare for the takeoff of the flying device 2. In the takeoff preparation process, the vehicular device 3 communicates with the flying device 2 (T1). At this time, the vehicular device 3 exchanges the level of the battery 26, the self-diagnosis result, the data of the standard position, and the like. The data to be exchanged is not limited to the above information.

Next, the vehicular device 3 determines whether or not a takeoff operation has been entered (T2). In the present embodiment, when the takeoff button B3 is operated, the vehicular device 3 determines that the takeoff operation has been entered. On the other hand, when it is determined that the takeoff operation has not been entered (NO in T2), the vehicular device 3 determines whether or not a predetermined automatic takeoff requirement has been established (T3).

The automatic take-off requirement is a requirement for causing the flying device 2 to takeoff even if the driver does not perform a takeoff operation. The automatic take-off requirement is set, for example, when the route of the destination is determined, when the route approaches a place where many accidents occur in the guide route, when the route approaches a road that passes for the first time, or the like. A location where the flight of the flying device 2 is permitted by laws, regulations, and the like is also set as a requirement.

When it is determined that the takeoff operation has not been entered (NO in T2) and the automatic takeoff requirement has not been satisfied (NO in T3), the vehicular device 3 proceeds to Step T1.

On the other hand, when it is determined that the takeoff operation has been entered (YES in T2) or when it is determined that the automatic takeoff requirement has been satisfied (YES in T3), the vehicular device 3 opens the slide door 7 (T4) and transmits the takeoff instruction to the flying device 2 (T5). At this time, the vehicular device 3 notifies the flying device 2 that the opening of the slide door 7 has been completed.

Upon receiving the takeoff instruction (YES in S2), the flying device 2 determines whether or not the take-off is enabled (S3). At this time, the flying device 2 confirms that an abnormality has not occurred, that the level of the battery 26 is sufficient, that a speed of the vehicle 5 is not too high, or the like, and determines that the take-off is enabled when it is determined that flight is enabled. The state in which the slide door 7 is opened is also a criterion as to whether or not the take-off is enabled.

Upon determination that the takeoff is not enabled (NO in S3), the flying device 2 communicates with the vehicular device 3 (S1) and notifies the vehicular device 3 that the takeoff is disabled.

On the other hand, upon determination that the takeoff is enabled (YES in S3), the flying device 2 takes off by autonomous flight (S4). At this time, when the takeoff is completed, the flying device 2 notifies the vehicular device 3 that the takeoff is completed. Then, the flying device 2 autonomously flies to the standard position.

On the other hand, upon receiving a notification that the takeoff has been completed from the flying device 2, the vehicular device 3 closes the slide door 7 (T6). In the event that the vehicular device 3 is notified that the flying device 2 cannot take off, the vehicular device 3 closes the slide door 7 and stops the takeoff.

The flying device 2 takes off from the vehicle 5 in such a procedure.

<<Procedure for Providing Information to Drivers>>

Hereinafter, a procedure for providing information to the driver will be described mainly with reference to FIGS. 11 to 17. The flying device 2 that has taken off from the vehicle 5 executes a position control process for controlling the flight position in the information collection process shown in FIG. 11 (S10).

In the position control process shown in the drawing, the flying device 2 acquires the flight position (S100), acquires the vehicle position from the vehicular device 3 (S101), and calculates a relative position to the vehicle 5 (S102).

Next, the flying device 2 determines whether or not the flight position deviates from the standard position based on a difference between the flight position and the relative position (S103). When it is determined that the flight position deviates from the standard position (YES in S103), the flying device 2 corrects the flight position (S104), and then returns to the information collection process.

In other words, the flying device 2 corrects the flight position so that the relative position to the vehicle 5 becomes the standard position. On the other hand, when it is determined that the flight position does not deviate from the standard position (NO in S103), the flying device 2 returns to the information collection process as it is.

In this way, the flying device 2 flies while moving until the flight position coincides with the standard position, and when the flight position reaches the standard position, the flying device 2 flies in a state of being maintained at the standard position.

The flying device 2 having reached the standard position captures an image of the periphery of the vehicle 5 (S11), and transmits the captured image to the vehicular device 3 (S12). The orientation of the camera 4 is adjusted until the flight position reaches the standard position.

Subsequently, the flying device 2 determines whether or not an adjustment instruction has been received (S13), whether or not a return instruction has been received (S14), and whether or not an automatic return requirement has been satisfied (S16), and when any of those requirements is negative (NO in S13, NO in S15, NO in S16), the process proceeds to Step S10. Then, the flying device 2 repeats imaging and transmission while adjusting the flight position.

As a result, an image of the periphery of the vehicle 5 is transmitted from the flying device 2 to the vehicular device 3 in real time. In other words, the flying device 2 collects information indicating the situation of the periphery of the vehicle 5 in real time. The return of the flying device 2 will be described later.

On the other hand, after the takeoff of the flying device 2 has been completed, the vehicular device 3 executes the information provision process shown in FIG. 13. In the information provision process, upon receiving the image from the flying device 2 (T10), the vehicular device 3 displays the received image (T11). The image is demodulated by the image demodulation unit 56 and then displayed on the image display unit 51. As a result, the driver is provided with an image, that is, realistic information on the situation of the periphery of the vehicle 5.

The vehicular device 3 performs an identification process for detecting the moving object or the like and generating an identification image (T12). In the identification process shown in FIG. 14, the vehicular device 3 analyzes the received image (T120) and detects an object (T121). At this time, patterns of shapes, colors, and the like of fixed objects such as houses, electric poles, traffic lights, trees, and the like are registered in advance as background objects which are not objects to be detected.

For that reason, the vehicular device 3 detects the object in a state in which the background objects are excluded by pattern recognition or the like. At this time, the vehicular device 3 detects an object other than the background, which positionally changes in time series, as the moving object. On the other hand, the vehicular device 3 detects, as a stationary object, the object which is different from a background object, does not move and is positioned on the course of the vehicle 5. For that reason, for example, other vehicles 8 are detected as the stationary objects when the vehicles 8 are stopped, and are detected as the moving objects when those vehicles 8 are traveling. Hereinafter, the stationary object positioned on the course of the vehicle 5 will be referred to as a contact stationary object for convenience.

Next, the vehicular device 3 determines whether or not the detected object includes the moving object, that is, whether or not the moving object exists in the image (T122). In this example, the moving object means an object that is moving in reality. Therefore, for example, an object traveling at the same speed as the flying device 2 and whose position in the captured image has not changed is detected as a moving object instead of a stationary object.

When it is determined that the moving object is included (YES in T122), the vehicular device 3 generates an identification image for the moving object (T123). In other words, the vehicular device 3 generates an image for identifying the moving object included in the image.

In the present embodiment, as exemplified in FIG. 6, the vehicular device 3 generates, as an identification image for the moving object or the stationary object, for example, elliptical marks M1 to M3, or a mark M4 having a sharp outer shape and a convex and concave shape, which is conscious of contact, in a shape that generally surrounds the entire moving object of the object. The vehicular device 3 generates and displays a host vehicle mark M0 for the vehicle 5.

The marks M1 to M4 may fill the moving objects. In the present embodiment, the flying device 2 captures an image such that a center of a lower end of a screen is located at the vehicle position in the standard use mode. For that reason, for example, even if the image of the other vehicle 8B is filled with the mark M4, if the mark M4 is displayed on a right side of the center of the screen, the driver can immediately recognize that the other vehicle 8B approaching the front right side is present. The shape of the identification image shown in FIG. 6 is only an example, and another shape can be adopted.

Next, the vehicular device 3 determines whether or not there is an approaching moving object (T124). In this example, the approaching moving object means a moving object moving in a direction approaching the vehicle 5 or the course of the vehicle 5 among the detected moving objects. At this time, the vehicular device 3 detects the approaching moving object based on the position of the vehicle 5 and a temporal change of the moving object at one time.

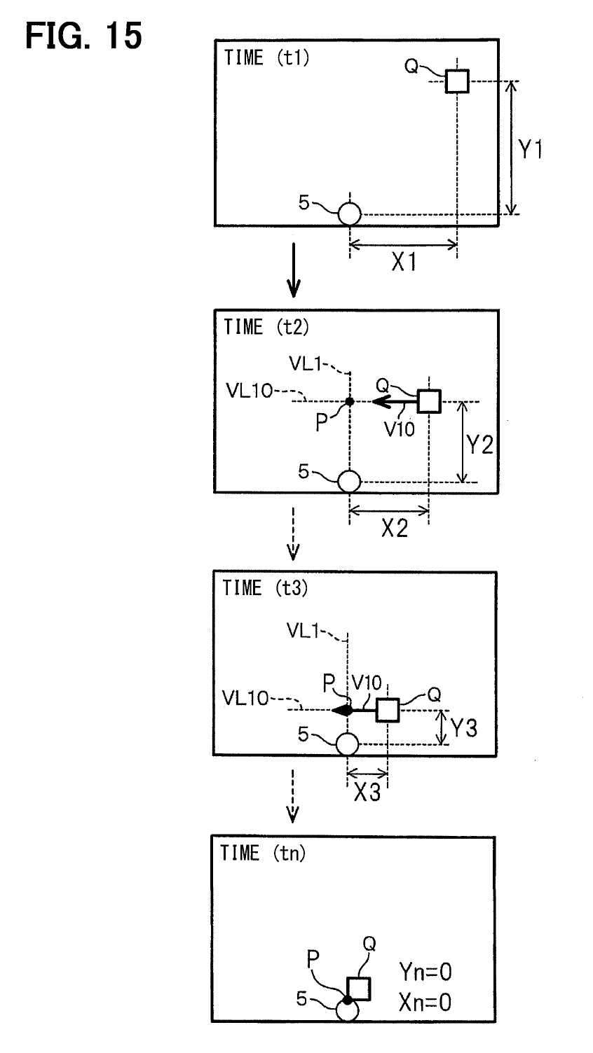

More specifically, for example, as shown in time series in FIG. 15, it is assumed that a moving object (Q) is detected at a time (t1). At this time, the vehicular device 3 identifies a horizontal distance and a vertical distance between the vehicle 5 and the moving object (Q). At the time (t1), it is assumed that the horizontal distance is X1 and the vertical distance is Y1. The horizontal distance and the vertical distance may be converted into actual distances, or an image coordinate system may be used.

Subsequently, the vehicular device 3 identifies the horizontal distance and the vertical distance between the vehicle 5 and the moving object (Q) at a time (t2) after the time (t1). The time (t2) may be a time at which a time in which the moving direction and the moving speed of the moving object can be identified has elapsed, but it is preferable that the time (t2) is as short as possible from the time (t1) in order to notify the driver at an earlier stage. At this time (t2), it is assumed that a horizontal distance between the vehicle 5 and the moving object (Q) is X2 and the vertical distance is Y2.

In this case, the vector of the moving object (Q) at the time (t2) can be expressed by the following expression. Hereinafter, the vector of the moving object (Q) is referred to as a moving object vector (V10) for convenience.

((X2−X1),(Y2−Y1))/(t2−t1)

The vehicular device 3 determines the moving object that moves in the direction of approaching the vehicle 5, or the moving object that moves in the direction of approaching the road of the vehicle 5, as the approaching moving object, with the use of a mobile-to-vector (V10), that is, based on a change in a relative position of the vehicle 5 and the moving object (Q).

For example, in the case of FIG. 6, since the other vehicle 8C moving in the direction away from the intersection moves in the direction away from the vehicle 5, it is determined that the other vehicle 8C is not approaching the vehicle 5. In other words, it is determined that the other vehicle 8C is not the approaching moving object although the other vehicle 8C is the moving object.

On the other hand, the other vehicle 8A traveling in the oncoming lane is determined to be the approaching moving object because the other vehicle 8A is moving in a direction in which the distance from the vehicle 5 becomes shorter. In addition, the other vehicle 8B traveling toward the intersection and the person 9 walking toward the intersection are determined as the approaching moving objects because those objects are moving in a direction approaching the course of the vehicle 5.

The vehicular device 3 generates the identification image for the approaching moving object when it is determined that there is an approaching moving object (T125). At this time, the vehicular device 3 generates the identification image generated in Step T123 and the identification image generated in Step T125 in different display modes. In the present embodiment, different colors are used as different modes of the identification image.

For example, in FIG. 6, the mark M2 generated for another vehicle 8C is a symbol of the moving object, but the mark M2 is different from the mark M1 of another vehicle 8B, which is the approaching moving object. For example, the mark M1 is generated in yellow, and the mark M2 is generated in green. In that case, it is generally considered that it can be intuitively grasped that the mark M1 displayed in yellow has a higher degree of danger than the mark M2 displayed in green. FIG. 6 schematically shows that the display modes of the mark M1 and the mark M2 are different from each other by a difference in hatching.

Next, in the identification process shown in FIG. 14, the vehicular device 3 determines whether or not there is a crossing moving object (T126). In this example, the crossing moving object means a moving object whose moving direction crosses the traveling direction of the vehicle 5 among the detected moving objects. The crossing moving object means a moving object whose moving direction crosses the moving direction of the vehicle 5 regardless of whether or not there is a possibility of contact between the moving object and the vehicle 5.

The vehicular device 3 determines whether or not a virtual line (VL10) which virtually extends the moving object vector (V10) at the time (t2) shown in FIG. 15 crosses a virtual line (VL1) which extends in the traveling direction of the vehicle 5, in the present embodiment, basically upward in the image. In FIG. 15, the virtual line (VL10) and the virtual line (VL1) intersect with each other at a point P. For that reason, the vehicular device 3 determines that the moving object (Q) is the crossing moving object.

The vehicular device 3 generates an identification image indicating the moving object (Q) as the crossing moving object in an identifiable manner. At that time, the vehicular device 3 generates the identification image of a display mode different from that of the approaching moving object with respect to the crossing moving object. In the present embodiment, the vehicle device 3 generates the identification images having different colors between the crossing moving object and the approaching moving object.

Specifically, in FIG. 6, for example, the other vehicle 8B and the person 9 are determined to be crossing moving objects because those objects are moving in the direction that crosses the road of the vehicle 5. For that reason, the mark M4 generated for the other vehicle 8B and the mark M3 generated for the person 9 are generated in red, for example. In other words, the identification image for the crossing moving object is generated so as to be distinguishable from the identification image for the approaching moving object.

In that case, it is generally considered that it can be intuitively recognized that the marks M3 and M4 displayed in red have a higher degree of danger than the mark M1 displayed in yellow. FIG. 6 schematically shows that the display modes of the marks M3 and M4 are different from each other by the difference in hatching. As will be described later, the mark M4 for the other vehicle 8B is generated in a display mode different from that of the mark M3 for the person 9 in order to distinguishably indicate the possibility of contact.

This makes it possible to obtain the driver's attention because red is generally a color frequently used to indicate danger, and to strongly draw the driver's attention. In addition, the driver can immediately recognize that a moving object or the like to be noted exists because the red mark falls within the field of view without paying attention to the screen.

In this manner, the vehicular device 3 provides the driver with information that the crossing moving object is present at the point in time when the crossing moving object is detected, that is, at a point in time before the determination of the presence or absence of the contact is performed. This makes it possible for the driver to know the presence of the crossing moving object at an earlier stage and to perform so-called predictive driving while paying attention to the crossing moving object.

In other words, the vehicular device 3 generates the identification image at a point in time of detecting the crossing moving object based on not an idea of surely determining whether or not to contact for a certain amount of time, but an idea of notifying the driver of a potential contact as soon as possible.

Incidentally, if the crossing moving object has been detected, even if the vehicle 5 and the crossing moving object are out of contact with each other at the time of detection, since the moving directions crossing each other, it is considered that there is a potential danger of contact between those objects in the future. For that reason, the vehicular device 3 further determines the possibility of contact with the vehicle 5 when the crossing moving object is detected at Step T127 in which the crossing moving object is detected.

Specifically, vehicular device 3 predicts the relative position of the vehicle 5 and the mobile object (Q) at the time (t3) of virtually advancing time with the use of the moving object vector (V10) identified at the time (t2) as shown in FIG. 15. At that time, it is assumed that the horizontal distance is X3 and the vertical distance is Y3 at the time (t3). In that case, at the time (t3), the vehicle 5 and the moving object (Q) do not come into contact with each other.

Then, the vehicular device 3 further advances the time virtually, and determines whether there is a time (n) at which the horizontal distance and the vertical distance become 0. For example, when the horizontal distance is Xn=0 and the vertical distance is Yn=0 at a time (n), the vehicular device 3 determines that the vehicle 5 and the moving object (Q) are likely to come into contact with each other or are highly likely to come into contact with each other when the vehicle 5 travels as it is. At that time, the vehicular device 3 uses the vehicle information acquired from the ECU 42 for the velocity of the vehicle 5 in order to improve the determination accuracy.

In that case, in the identification process shown in FIG. 14, the vehicular device 3 generates an identification image for the crossing moving object and an identification image for the crossing moving object that may be in contact with the vehicle 5 (T127). Specifically, if it is determined that there is a possibility of contact or high possibility of contact with the other vehicle 8B shown in FIG. 6, M4 with a display mode different from that of the person 9 which is the crossing moving object, is generated for the other vehicle 8B.

In the present embodiment, the mark M4 blinks in red, and a shape of the mark M4 is also different from that of the mark M3 indicating the crossing moving object in order to be aware of the contact. This makes it possible to obtain the driver's attention by flashing in red color, which generally indicates danger, and to strongly draw the driver's attention because of the shape which makes the driver aware of the contact. In addition, even when the driver looks ahead for driving, a red flashing state occurs in the image display unit, that is, in the field of view of the driver, so that the driver can immediately recognize that the moving object or the like to be noted exists without watching the screen.

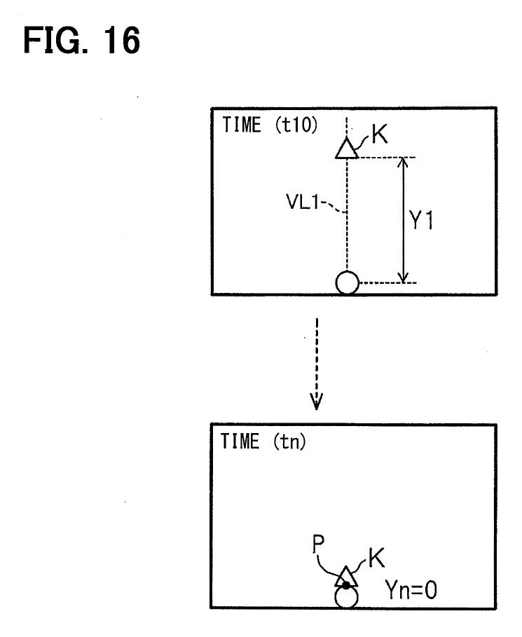

Although the moving object has been described so far, it is also conceivable that the vehicle 5 may come into contact with a stationary object. For that reason, in the identification process shown in FIG. 14, the vehicular device 3 determines whether or not there is a contact stationary object (T128). Specifically, for example, as shown in FIG. 16, it is assumed that an object (K) which is a stationary object but is different from the background is detected at a time (t10).

In this case, the vehicular device 3 determines whether or not the object (K) is located on the virtual line (VL1). The vehicular device 3 determines whether or not the object (K) is located on a road on which the vehicle is traveling, even if the object (K) does not overlap with the virtual line (VL1) at the present time. In other words, the vehicular device 3 determines whether or not the object (K) is positioned on the course of the vehicle 5. In this example, the “on the course” includes the traveling direction of the vehicle 5, or a planned traveling position at which the vehicle 5 actually travels.

In the case of FIG. 16, since the object (K) is located on the virtual line (VI1), the vehicular device 3 determines the object (K) as a contact stationary object. In other words, if the vehicle 5 travels as it is, it is determined that there is a possibility that the vehicle 5 may come into contact with the object (K) at a time (tn), for example, or that there is a high possibility of contact with the object (K). In that case, the vehicular device 3 generates an identification image indicating that the object (K) can be identified as a contact stationary object (T129). Although illustration of the identification image for the object (K) is omitted, a shape or color different from that of the moving object can be used.

With the detection of the contact stationary object in this manner, the vehicular device 3 can promptly notify the driver of the existence of the object or the possibility of the contact even in a situation where the driver is not generally supposed, such as a fallen object on the road or the vehicle 5 stopping on a road side band of an expressway.

The vehicular device 3 detects a moving object or a contact stationary object, performs the identification process for generating the identification image for the detected moving object or the contact stationary object, and then returns to the information provision process shown in FIG. 13. Then, the vehicular device 3 executes the notification process (T13).

The vehicular device 3 displays the identification image in the notification process shown in FIG. 17 (T130). This provides the driver with information such as whether or not the moving object exists, whether the moving object is an approaching moving object or a crossing moving object, whether there is a possibility of contact, and whether a contact stationary object exists, as shown in FIG. 6.

When the crossing moving object is present (YES in T131) or when the contact stationary object is present (YES in T132), the vehicular device 3 also performs voice notification from a speaker. This makes it possible to prompt the driver who concentrates on driving and does not view the image display unit 51 to confirm the image, that is, to promptly grasp the potential danger.

<<Procedure for Instructing Adjustment to Flying Device 2>>

When the notification process is performed, the vehicular device 3 determines whether or not an adjustment operation has been entered in the information provision process shown in FIG. 13 (T14). In that case, when any of the adjustment buttons displayed on the operation display unit 52 shown in FIG. 7 is operated, the vehicular device 3 determines that the adjustment operation has been entered.

Then, the vehicular device 3 determines that the adjustment operation has been entered (YES in T14), and transmits an adjustment instruction to instruct the input adjustment to the flying device 2 (T15). Specifically, when the up button B8 is operated, the vehicular device 3 transmits an adjustment instruction for raising the altitude to the flying device 2, and when the down button B9 is operated, the vehicular device 3 transmits an adjustment instruction for lowering the altitude to the flying device 2.

Further, the vehicular device 3 transmits an adjustment instruction to move away from the vehicle 5 to the flying device 2 when the far button B10 is operated, and transmits an adjustment instruction to move toward the vehicle 5 to the flying device 2 when the approach button B11 is operated.

In addition, the vehicular device 3 transmits an adjustment instruction to the flying device 2 for directing the camera 4 more forward than the present when the forward button B12 is operated, and transmits an adjustment instruction for directing the camera 4 more downward than the present to the flying device 2 when the downward button B13 is operated.

When any one of the standard button B5, the forward monitoring button B6, and the rearward monitoring button B7 is operated, the vehicular device 3 transmits an adjustment instruction instructing the flying device 2 to switch to any one of the “standard”, “forward monitoring”, and “rearward monitoring” imaging patterns.

As shown in FIG. 18, the “standard” captures an image of a range including the vehicle 5 from a position in front of the vehicle 5 and above at the standard position described above. The “standard” imaging pattern is set as an initial state of the flying device 2.

The “forward monitoring” images a range ahead of the “standard” at the standard position. In that case, the vehicle 5 may or may not be included in the image. The “forward monitoring” is selected when the driver wants to confirm a more distant situation or the like. As a result, it is possible to collect information on positions which are obstructed by the other vehicles 8 E, 8D and the like and are invisible to the driver of the vehicle 5, for example, when the other vehicles 8F and 8G are in contact in the front.

The “backward monitoring” images an area behind the “standard” at the standard position. In that case, the vehicle 5 may or may not be included in the image. The “forward monitoring” is selected, for example, when the user wants to check the backward direction at the time of a left turn, a right turn, or at the time of merging. This makes it possible to grasp, for example, the motorcycle 10 (refer to FIG. 3) traveling in a blind spot behind the driver.

On the other hand, when the flying device 2 receives the adjustment instruction (YES in S13) in the information collection process shown in FIG. 11, the flying device 2 adjusts the flight position indicated by the received adjustment instruction and the angle of the camera 4 (S14). This makes it possible to perform adjustment in accordance with an instruction from the driver.

<<Procedure for Resulting from Flying Device 2>>

The flying device 2 now returns to the vehicle 5 at some point in time. In the present embodiment, in the information collection process shown in FIG. 11, the flying device 2 returns to the vehicle 5 when a return instruction is transmitted from the vehicular device 3 (YES in S15) or when the automatic return requirement is satisfied (YES in S16). As the automatic return requirement, for example, a case in which the level of the battery 26 is less than a predetermined reference value, a case in which it is determined spontaneously that some abnormality has occurred, and there is a need to return, or the like is set in advance.

In the case of the return, the flying device 2 transmits a return request for notifying the vehicular device 3 of the return (S17), and then executes a return process (S18). In the return process shown in FIG. 19, the flying device 2 communicates with the vehicular device 3 as necessary (S180), and returns by autonomous flight (S182) when the return is enabled (S183).

If the return is not enabled such that the speed of the vehicle 5 is too fast or the vehicle position is lost, (NO in S182), the process proceeds to Step S1, and the flying device 2 transmits information that the return is disabled or the like to the vehicular device 3. In an emergency, for example, when an abnormality occurs, and there is a need to make an emergency landing, the flying device 2 also performs a notification of an emergency landing position or the like.

On the other hand, in the information provision process shown in FIG. 13, when a return operation has been entered (YES in T16), the vehicular device 3 transmits a return instruction (T17), and then executes a return preparation process for preparing a return of the flying device 2 (T19). In addition, the vehicular device 3 carries out a return preparation process when the vehicular device 3 receives a return request (YES in T17) (T19). In other words, the vehicular device 3 prepares to receive the returning flying device 2.

In the return preparation process shown in FIG. 20, the vehicular device 3 communicates with the flying device 2 as necessary (T190), opens the slide door 7 (T191), and waits for the return of the flying device 2 (NO in T192). Upon completion of the return (YES in T192), the vehicular device 3 closes the slide door 7 (T193). At that time, the completion of the return is confirmed by a communication with the flying device 2.

As described above, in the information provision system 1, the flying device 2 that has taken off from the vehicle 5 provides an image of the periphery of the vehicle 5 to the driver or the like in real time, and at the same time, the flying device 2 that has finished imaging is returned.

According to the information provision system 1 described above, the following effects can be obtained.

The information provision system 1 includes the flying device 2 having the camera 4 for capturing the image of the periphery of the vehicle 5 from above, and the vehicular device 3 having the vehicle-side control unit 48 for performing control for displaying the image captured by the flying device 2 on the vehicle-side display unit 54 in real time.

As a result, the situation in the vicinity of the vehicle 5 is provided to the driver as an image. In that case, because of the image, the situation around the vehicle 5 is provided with a sense of reality. In addition, the driver can easily grasp the situation around the vehicle 5 by obtaining the image, that is, information that is not schematically represented.

Since the situation can be easily grasped, a collision or the like slightly ahead such that there is another vehicle 8 approaching from a position which is not visible to the driver can be predicted. In other words, the driver can predict a potential danger in advance. As a result, so-called predictive operation can be performed, and safety can be improved.

In addition, since the flying device 2 captures the image of the periphery of the vehicle 5 from above, the situation of the position which is invisible to the driver can be grasped. As a result, it is considered that, for example, in the case where the driver is irritated by being caught in a traffic congestion, the driver is psychologically stable by grasping the cause of the traffic congestion. That is, driving can be supported not only from the physical aspect such as contact, but also from the psychological aspect of the driver.

Therefore, the information provision system 1 can provide information that accompanies a sense of reality such as an image, makes it easy to grasp the meaning, and can strongly draw attention to the driver.

The flying device 2 flies under autonomous control while maintaining a predetermined positional relationship with the vehicle 5. As a result, the driver can be provided with a situation in the vicinity of the vehicle 5 without the driver's operation, in other words, without distracting attention from driving. Therefore, a risk of deterioration of safety during driving can be reduced.

At that time, the flying device 2 identifies a predetermined positional relationship with the vehicle 5 based on the vehicle position received from the vehicular device 3. For that reason, in the normal use mode, the driver does not need to adjust the position of the flying device 2 or the like. Therefore, a risk of deterioration of safety during driving can be reduced.

The information provision system 1 transmits the adjustment instruction input by the driver or the like to the flying device 2, and the flying device 2 performs the adjustment instructed by the adjustment instruction for the position relative to the vehicle 5 or the orientation of the imaging unit based on the received adjustment instruction. As a result, in a case where an image desired by the driver cannot be captured due to an obstacle or the like, the periphery of the vehicle 5 can be imaged at a position desired or at an angle of the camera 4, which is desired by the driver.

The information provision system 1 displays the identification image generated for the detected object in such a manner as to follow a change in the display position of the object displayed on the vehicle-side display unit 54. As a result, even when the vehicle 5 travels and the positional relationship with the object changes, the driver can continuously grasp the object to be noted.

The information provision system 1 generates an identification image of a mode different between an object determined to be likely to be in contact with the vehicle 5 and an object determined to be unlikely to be in contact with the vehicle 5. This makes it possible to distinguish between objects that need to be noted and objects that need not be so noted. In that case, since the driver receives the information in a distinguished state, the priority for the potential danger is easily determined. This makes it possible to deal with the danger quickly and appropriately, and further, with sufficient margin.

The information provision system 1 detects a moving object approaching the vehicle 5 or the course of the vehicle 5 as an approaching moving object, and generates an identification image of a different mode between the approaching moving object and the moving object which is not the approaching moving object. This makes it possible to distinguish between a moving object to be noted because the moving object is approaching the vehicle 5 and a moving object that does not need much attention. As described above, this makes it possible to quickly and appropriately cope with the potential danger with a sufficient margin.

The information provision system 1 detects the moving object whose moving direction crosses the moving direction of the vehicle 5 as the crossing moving object, and generates the identification image of a different mode between the crossing moving object and the moving object that is not the crossing moving object. This makes it possible to distinguish the moving object which is likely to be in contact since the moving directions intersect with each other from the moving object which is unlikely to be in contact. As described above, this makes it possible to quickly and appropriately cope with the potential danger with a sufficient margin.

The information provision system 1 detects the stationary object positioned on the course of the vehicle 5 as a contact stationary object, and generates an identification image showing the contact stationary object so as to be identifiable. This makes it possible to inform the driver of an object, such as a fallen object existing on a road, the existence of which the driver is likely not to be normally aware of. This makes it possible to cope with the potential danger with a sufficient margin.

In the information provision system 1, the flying device 2 takes off from the vehicle 5 by autonomous control when a takeoff instruction is received and when a predetermined takeoff requirement is satisfied, and returns to the vehicle 5 by autonomous control when a return instruction is received and when a predetermined return requirement is satisfied. As a result, the operation for taking off and landing the flying device 2 can be simplified. Therefore, a risk of deterioration of safety during driving can be reduced.

Also, the vehicular device 3, which receives an image captured by the flying device 2 and displays the image on the vehicle-side display unit 54 in real time, can easily grasp the meaning, as in the information provision system 1 described above, and can provide information that has a sense of reality, is predictable in advance of a potential danger, and can strongly draw attention to the driver.

Also, the information provision program, for causing the vehicle-side control unit 48 of the vehicular device 3 connected to be able to communicate with the flying device 2 to execute the process of receiving the image captured by the flying device 2 and the process of displaying the received image on the vehicle-side display unit 54 in real time, can easily grasp the meaning, as in the information provision system 1 described above, and can provide information that has a sense of reality, is predictable in advance of a potential danger, and can strongly draw attention to the driver.

### Other Examples

The present disclosure is not limited to the configurations shown in the embodiments described above, and can be arbitrarily modified or combined without departing from the spirit of the present disclosure.

For example, the information provision system 1 can be configured so as to transmit route information capable of identifying a route guided by a route guidance unit such as the navigation apparatus 40 shown in FIG. 5 from the vehicle-side communication unit 50 to the flying device 2 so that the flying device 2 flies by autonomous control along the route along which the vehicle 5 is guided based on the received route information. This makes it unnecessary to adjust the position of the flying device 2 even if the vehicle 5 is traveling and the position of the vehicle 5 is changed. Therefore, safety during driving can be improved. In addition, this makes it possible to grasp the danger on the route at an early stage.

In addition, the information provision system 1 may be configured to include the vehicular device 3 that has the vehicle information acquisition unit which acquires the vehicle information capable of identifying the behavior of the vehicle 5, and transmits the acquired vehicle information to the flying device 2, and the flying device 2 that adjusts at least one of the flight position and the angle of the camera 4 based on the received vehicle information. In this case, the lighting of blinkers can be acquired as the vehicle information. As a result, for example, when turning left, a space behind the left, which is likely to become a blind spot of the driver, can be automatically adjusted to a position that can be imaged or an angle of the camera 4 at which the image can be captured.

The information provision system 1 can also include the flying device 2 which, when there is another road connected to one road on which the vehicle 5 is traveling, travels by autonomous control, to a position at which a connection position to which another road is connected and the vehicle 5 can be imaged, or adjusts the imaging unit to the orientation at which the connection position and the vehicle 5 can be imaged.

Alternatively, when the moving direction of the vehicle 5 changes, the information provision system 1 may be configured to include the flying device 2 that moves the rear of the vehicle 5 to a position where an image can be captured, or adjusts the imaging unit to a direction at which the rear of the vehicle 5 can be imaged.

As a result, for example, in a situation where the vehicle 5 turns left in FIG. 3, it is considered that the driver can be notified of that the motorcycle 10 is present behind the vehicle 5, that the person 9 is present on the left side, and the like, and safety can be enhanced.

In addition, the driver can be notified of the danger even if the driver is not aware of the other vehicle 8 or the person 9 that are joining, for example, such that the connected road is a road that joins in a three-dimensional union or a T-junction that is obstructed by the fence of a house. For that reason, even in situations where attention for connecting positions is tended to be neglected such as driving on priority roads, the existence of other vehicle 8 or the like can be notified to the driver.

Although the configuration of the vehicular device 3 having the operation device 41 and the navigation apparatus 40 is exemplified, the vehicular device 3 may include at least the vehicle-side communication unit 50 that communicates with the flying device 2, and the vehicle-side control unit 48 that performs control to display the image captured by the flying device 2 on the vehicle-side display unit 54 in real time. In other words, the vehicle-side display unit 54 may be provided to the outside of the vehicular device 3. For example, a configuration in which an image output unit is provided in the vehicular device 3 and an image is output to the display unit 44 of the navigation apparatus 40 or a display such as a so-called smart phone or a tablet type personal computer may be proposed.

Although the vehicle position acquisition unit 47 is provided in the vehicular device 3, the vehicle position acquisition unit 47 may be provided in an external device. For example, it is conceivable that a communication unit for communicating with an external device is provided in the vehicular device 3, and the vehicle position is acquired from an external device having the vehicle position acquisition unit 47. In that case, for example, if an external device such as a smart phone or a tablet personal computer is provided with a position acquisition unit, the vehicle position and route information can be acquired from the external device. In addition, if the external device includes the route guidance unit, route information may be acquired from the external device.

The configuration of acquiring the vehicle information by connecting the vehicular device 3 and the ECU 42 has been exemplified, but as the information provision system 1, the acquisition of the vehicle information is not required, and a configuration not connected to the ECU 42 can be provided.

Although the camera 4 capable of capturing a moving image and a still image in color and monochrome has been exemplified, a camera capable of capturing only a moving image or a camera capable of capturing only one of color and monochrome can be adopted.

The camera 4, the image modulation unit 30, and the image transmission unit 29A included in the flying device 2 may be integrally unitized, but may be configured to provide an interface for connecting the camera 4 to the flying device 2 side in order to allow a user to change the type of the camera 4, for example, or may be configured to employ the camera 4 capable of outputting a modulated image.

Although an example in which the flight position and the orientation of the camera 4 are individually adjusted has been described, the orientation of the camera 4 may be adjusted by following the change in the flight position. For example, the distance from the vehicle 5 and the altitude can be adjusted while maintaining a center position of the image. This makes it possible to reduce the possibility that the center position of the image deviates when the flight position changes, making it difficult to grasp the situation.

Although the image transmission unit 29A and the flight side transmission and reception unit 29 B are configured as individual communication ICs, those units may be configured by a common communication IC and a common antenna. The flight side transmission and reception unit 29B can also be configured by the transmission unit and the receiving unit with individual communication ICs and individual antennas.

Similarly, the vehicle-side communication unit 50 can also be configured by the image receiving unit 49A and the vehicle-side transmission and reception unit 49B with a common communication IC and a common antenna, or can be configured by the transmission unit and the reception unit with individual communication ICs and individual antennas. Alternatively, the vehicle position may be transmitted from the navigation apparatus 40 side to the flying device 2.

Although the configuration in which the image display unit 51, the operation display unit 52, and the situation display unit 53 each have an individual display has been exemplified, a configuration in which a common display is provided for any combination of the image display unit 51, the operation display unit 52, and the situation display unit 53 to switch the display content may be employed. For example, the image display unit 51, the operation display unit 52, and the situation display unit 53 can be configured by one display device.

Although the configuration in which the vehicle position is acquired from the vehicle 5 side has been exemplified, the vehicle position can also be identified by image recognition. For example, the vehicle 5 is associated with the flying device 2 in advance, for example, by storing the shape, color, and the like of the vehicle 5 in the flying device 2, the vehicle 5 is identified in the image captured by the flying device 2, and the relative position to the flight position is identified based on the flight position and the specification of the camera 4 such as the angle of view, thereby being capable of identifying the vehicle position.

Although the moving object and the stationary object are detected, only the moving object can be detected. This makes it possible to help preventing accidents between the moving objects such as vehicles and contacts between a vehicle and a person, which are general accident modes.

Although an example in which the identification image is generated for the contact stationary object has been described in the embodiment, requirements for generating the identification image can be configured to be settable. The requirement may be, for example, 50 m or more ahead of the vehicle 5. This is to reduce the fact that the other vehicle 8 which is stopped, that is, the other vehicle 8 which is visible to the driver is notified as the contact stationary object when the host vehicle is stopped following the other vehicle 8 which is stopped waiting for a traffic signal, for example. From the viewpoint of rear-end collision prevention, it is also considered effective to notify the other vehicle 8 or the like which can be visually recognized by the driver.

Although the configuration in which the identification image is displayed for all of the detected objects has been exemplified, the configuration in which the driver can set which object among the detected objects the identification image is displayed for can be used. For example, the identification image may be displayed only on the crossing moving object, the identification image may be displayed only on the crossing moving object and the approaching moving object, or the identification image may be displayed only on the crossing moving object and the contact stationary object. This makes it possible to reduce the possibility that the identification image is excessively displayed and the user may be unable to make a determination.

Although an example in which the object detection unit, the image generation unit, the contact assessment unit, the approach determination unit, the intersection determination unit, and the stationary object determination unit are configured by the image analysis unit 57 has been described, each unit can be configured individually, or a common configuration can be adopted in any combination. For example, each of the determination units and the image generation unit can be configured as separate units. Further, a configuration in which arbitrary functions are distributed to the vehicle-side control unit 48 and the like can be employed.

The standard position may be changed, for example, according to the speed of the vehicle 5. In this case, for example, a distance based on an average speed in an urban area is set as an initial value, and if the actual speed of the vehicle 5 is higher than the average speed, a predetermined distance (L) may be set to be longer, and if the actual speed of the vehicle 5 is lower, the predetermined distance (L) may be set to be shorter. As a result, for example, when the speed is high, the situation in a more distant area can be grasped, which is conceivable to be more useful for improving the safety. In that case, the standard position can be adjusted by acquiring the vehicle speed at the time of taking off, or the distance can be changed according to the change in the vehicle speed even during the flight.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An information provision system comprising:
a flying device including an imaging unit that images a periphery of a vehicle from above, a flight-side communication unit that communicates with the vehicle, and a flight-side control unit that controls flight by remote control and flight by autonomous control, and controls transmitting an image captured by the imaging unit to the vehicle; and
a vehicular device including a vehicle-side communication unit that communicates with the flying device, and a vehicle-side control unit that controls displaying an image captured by the flying device and received by the vehicle-side communication unit on a vehicle-side display unit in real time, wherein:
the flying device further includes a flight position acquisition unit that acquires a flight position indicating a position of the flying device; and
the flying device flies by autonomous control while maintaining a predetermined positional relationship with the vehicle.

2. The information provision system according to claim 1, wherein:
the vehicular device further includes a vehicle position acquisition unit that acquires a vehicle position indicating a position of the vehicular device;
the vehicular device transmits an acquired vehicle position to the flying device; and
the flying device specifies the predetermined positional relationship with the vehicle based on a received vehicle position, and maintains the predetermined positional relationship with the vehicle.

3. The information provision system according to claim 1, wherein:
the vehicular device further includes a route guidance unit that guides the vehicle to a predetermined destination, and transmits route information for specifying a route guided by the route guidance unit from the vehicle-side communication unit to the flying device; and
the flying device flies by autonomous control along the route by which the vehicle is guided, based on a received route information.

4. The information provision system according to claim 1, wherein:
the vehicular device further includes an operation unit that receives an adjustment instruction for adjusting at least one of the position of the flying device relative to the vehicle and an orientation of the imaging unit,
the vehicular device transmits a received adjustment instruction from the vehicle-side communication unit to the flying device; and
the flying device adjusts the at least one of the position relative to the vehicle and the orientation of the imaging unit, which is instructed by the adjustment instruction, based on the received adjustment instruction.

5. The information provision system according to claim 1, further comprising:
an object detection unit that analyzes the image captured by the imaging unit and detects an object in the image; and
an image generation unit that generates an identification image which shows the object detected by the object detection unit in an identifiable manner, wherein:
the vehicular device displays the identification image generated for the object in accordance with a change in a display position of the object displayed on the vehicle-side display unit.

6. The information provision system according to claim 5, further comprising:
a contact determination unit that determines a possibility that the object detected in the object detection unit comes in contact with the vehicle, wherein:
the image generation unit generates the identification image of the object determined to have a possibility of coming in contact with the vehicle in a different mode from the identification image of the object determined to have no possibility of coming in contact with the vehicle.

7. The information provision system according to claim 5, wherein:
the object detection unit determines whether a detected object is a moving object;
the object detection unit includes an approach determination unit that determines whether the object determined as the moving object approaches the vehicle or a course of the vehicle; and
the image generation unit generates the identification image of the object determined to approach the vehicle in a different mode from the identification image of the object determined not to approach the vehicle.

8. The information provision system according to claim 5, wherein:
the object detection unit detects whether a detected object is a moving object;
the object detection unit includes a crossing determination unit that determines whether a traveling direction of the object determined as the moving object intersects with a traveling direction of the vehicle; and
the image generation unit generates the identification image of the moving object whose traveling direction is determined to intersect with the traveling direction of the vehicle in a different mode from the identification image of the moving object whose traveling direction is determined not to intersect with the traveling direction of the vehicle.

9. The information provision system according to claim 5, wherein:
the object detection unit detects a stationary object other than a moving object;
the object detection unit includes a stationary object determination unit that determines whether a detected stationary object is positioned on a course of the vehicle; and
the image generation unit generates the identification image which shows the stationary object determined to be positioned on the course in an identifiable manner.

10. The information provision system according to claim 1, wherein:
the vehicular device transmits a takeoff instruction for instructing takeoff of the flying device and a return instruction for instructing return of the flying device from the vehicle-side communication unit to the flying device;
the flying device takes off from the vehicle and returns to the vehicle; and
the flying device takes off from the vehicle by autonomous control when receiving the takeoff instruction or when a predetermined takeoff condition is satisfied, and returns to the vehicle by autonomous control when receiving the return instruction or when a predetermined return condition is satisfied.

11. A vehicular device comprising:
a vehicle-side communication unit that communicates with a flying device having an imaging unit and imaging a periphery of a vehicle from above; and
a vehicle-side control unit that controls displaying an image captured by the flying device and received by the vehicle-side communication unit on a vehicle-side display unit in real time, wherein:
the flying device further includes a flight position acquisition unit that acquires a flight position indicating a position of the flying device; and
the flying device flies by autonomous control while maintaining a predetermined positional relationship with the vehicle.

12. A non-transitory computer-readable storage medium comprising instructions being executed by a computer, the instructions including a computer-implemented method for controlling a vehicle-side control unit in a vehicular device, communicably connected to a flying device having an imaging unit and imaging a periphery of a vehicle from above, the instructions comprising:
receiving an image captured by the flying device; and
displaying a received image on a vehicle-side display unit in real time, wherein:
the flying device further includes a flight position acquisition unit that acquires a flight position indicating a position of the flying device; and
the flying device flies by autonomous control while maintaining a predetermined positional relationship with the vehicle.
